(19) United States
(12) Patent Application Publication
(10) Pub. No.: US 2011/0153809 A1
(43) Pub. Date: Jun. 23, 2011

(54) Legal Intercept

(75) Inventors: George Ghanem, Redmond, WA (US); Lawrence Felix Bizga, Monroe, WA (US); Niraj K. Khanchandani, Redmond, WA (US)

(73) Assignee: Microsoft Corporation, Redmond, WA (US)

(21) Appl. No.: 12/645,485

(22) Filed: Dec. 23, 2009

(51) Int. Cl. G06F 15/16; G06F 15/173

(52) U.S. Cl. 709/224; 709/228

(57) ABSTRACT

Aspects of the subject matter described herein relate to silently recording communications. In aspects, data associated with a request to establish a communication is modified to cause the communication to be established via a path that includes a recording agent. Modification may include, for example, adding, changing, and/or deleting data within the data. The data as modified is then passed to a protocol entity that uses the data to establish a communication session. Because of the way in which the data has been modified, the protocol entity selects a path that includes the recording agent. The recording agent is then able to silently record the communication.

### BACKGROUND

Plain old telephone service (POTS) allows people from all over the world to talk to each other through the use of telephones. POTS has been around since the late 19th century and has remained basically the same. In traditional usage, POTS has transmitted voice communications using electrical signals that are transmitted via pairs of wires. Central offices establish connections between callers and those called.

Sometimes, a government or one of its agencies may need to monitor communications between telephone users. To do this with POTS, after obtaining the appropriate legal permission, a recording device may be placed at a central office associated with a selected telephone number. Electrical signals corresponding to sound to and from the telephones at the selected telephone number may be monitored and transformed into sound. This sound may then be recorded by the recording device without the telephone users being aware of the recording. With new Voice over Internet Protocol (VoIP) and other communication technology, the POTS model for recording communications does not work.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to silently recording communications. In aspects, data associated with a request to establish a communication is modified to cause the communication to be established via a path that includes a recording agent. Modification may include, for example, adding, changing, and/or deleting data within the data. The data as modified is then passed to a protocol entity that uses the data to establish a communication session. Because of the way in which the data has been modified, the protocol entity selects a path that includes the recording agent. The recording agent is then able to silently record the communication.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is an exemplary timing diagram that illustrates a sequence of events that may occur in accordance with aspects of the subject matter described herein;

FIG. 4 is a block diagram that represents an apparatus configured in accordance with aspects of the subject matter described herein; and

FIGS. 5-6 are flow diagrams that generally represent actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.” Other definitions, explicit and implicit, may be included below.

### Exemplary Operating Environment

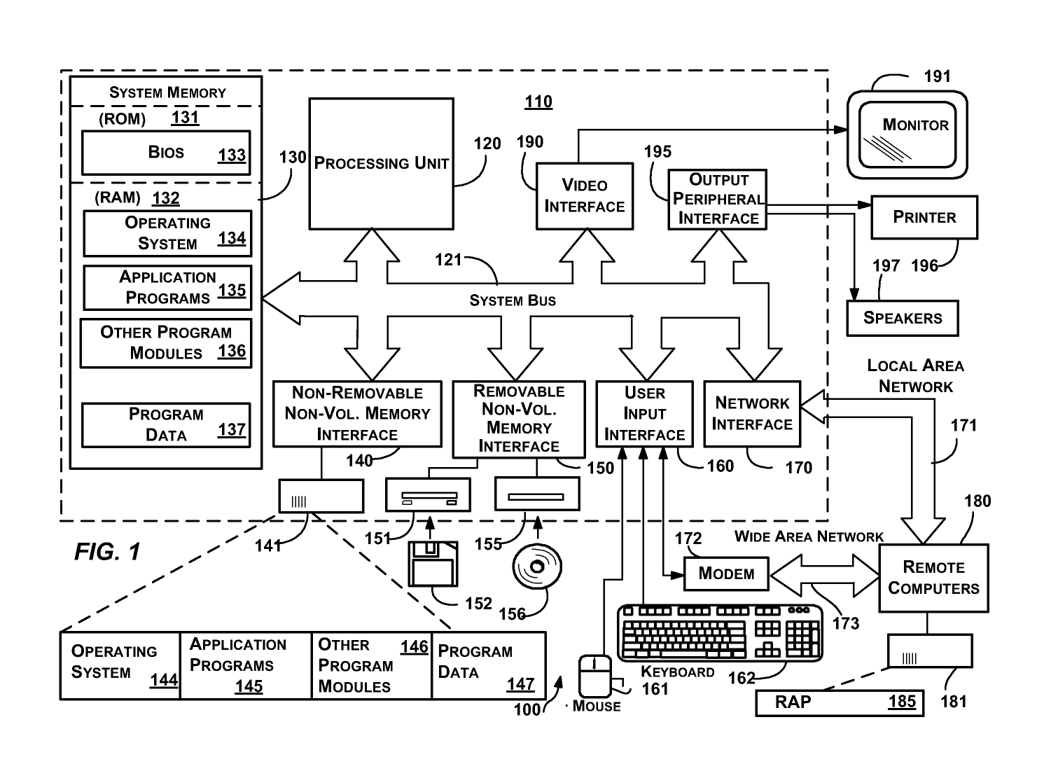

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), smartphones, gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Legal Intercept

As mentioned previously, traditional techniques for silently recording telephone communication may not work correctly with VoIP and other network-based communication technology. As used hereafter, the term VoIP is used to refer to standard VoIP as well as any other form of packet-based communication that may be used to transmit audio over a wireless and/or wired network. For example, VoIP may include audio messages transmitted via gaming systems, instant messaging protocols that transmit audio, Skype and Skype-like applications, meeting software, video conferencing software, and the like.

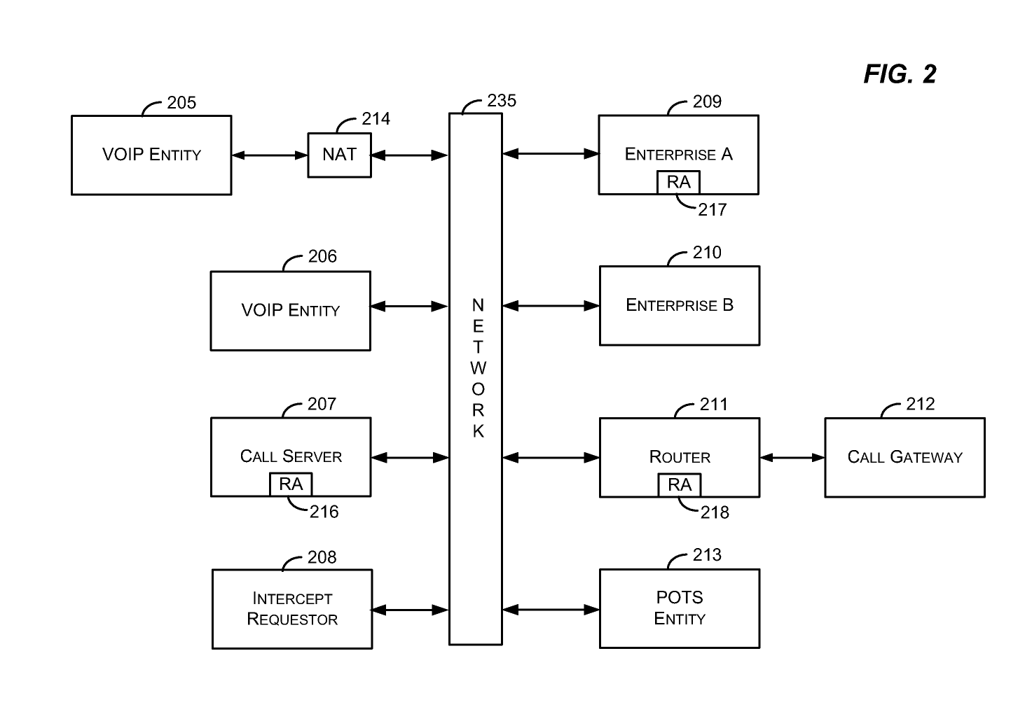

FIG. 2 is a block diagram representing an exemplary environment in which aspects of the subject matter described herein may be implemented. The environment may include VoIP entities 205-206, a call server 207, an intercept requestor 208, enterprises 209-210, a router 211, a call gateway 212, a POTS entity 213, a network address translation (NAT) entity 214, and other entities (not shown). The various entities may be located relatively close to each other or may be distributed across the world. The various entities may be able to communicate with each other via various networks including intra- and inter-office networks and the network 235.

One or more of the entities may include a recording agent. In one embodiment, only the router 211 includes a recording agent 218. In another embodiment, the call gateway 212 may include a recording agent (not shown) and the recording agent 218 may be omitted. In another embodiment, one or more other entities (e.g., the entities 205, 207, and 208) may include recording agents.

In an embodiment, the network 235 may comprise the Internet. In an embodiment, the network 235 may comprise one or more local area networks, one or more telephone networks, one or more wide area networks, direct connections, virtual connections, private networks, virtual private networks, some combination of the above, and the like.

A VoIP entity, such as the VoIP entities 205-206, may comprise any device that is capable of sending and receiving IP packets that encode voice data. Such devices may include, for example, dedicated VoIP phones, regular phones connected to a VoIP gateway, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), mobile devices such as smartphones, gaming devices, appliances including set-top, media center, or other appliances, automobile-embedded or attached computing devices, other mobile devices, distributed computing environments that include any of the above systems or devices, and the like. An exemplary device that may be configured to act as one of the above comprises the computer 110 of FIG. 1.

The VoIP entities 205-206 may connect to the network 235 via a NAT device, gateway, router, switch, cell phone tower, some other network device, or the like.

A VoIP entity may have a transducer (e.g., a microphone) that generates electrical signals from sound waves. The electrical signals may then be transformed into digital data to send in IP packets. A VoIP entity may also have components to transform digital signals into electrical signals and a transducer (e.g., speakers) that generates sound waves from the electrical signals.

The term data is to be read broadly to include anything that may be represented by one or more computer storage elements. Logically, data may be represented as a series of 1's and 0's in volatile or non-volatile memory. In computers that have a non-binary storage medium, data may be represented according to the capabilities of the storage medium. Data may be organized into different types of data structures including simple data types such as numbers, letters, and the like, hierarchical, linked, or other related data types, data structures that include multiple other data structures or simple data types, and the like. Some examples of data include information, program code, program state, program data, other data, and the like.

The enterprises 209-210 may include VoIP and/or POTS entities. Network entities of the enterprises 209-210 may be connected to the network 235 via one or more NAT devices (not shown) described in more detail below. The enterprises 209-210 may include a private branch exchange (PBX) that makes connections between entities within the enterprise and selects trunk lines for communicating with the central telephone office as appropriate. An enterprise may include components that facilitate the use of VoIP entities. One or more of these components may be built into the PBX or may reside at other places in networks hosted by the enterprise.

As used herein, the term “enterprise” is used for illustration only and is not intended to be limited to large companies or organizations. Indeed, an enterprise may refer to any size organization.

The call server 207 is a component that receives control packets regarding setting up communication sessions between entities. The call server 207 may assist in negotiating a path by which the two entities are to communicate with each other. The call server 207 may be responsible for relaying invite requests from a requesting one of the entities to a receiving one of the entities. The call server 207 may be configurable to provide the data to a recording agent before establishing the communication session. In one embodiment, the recording agent 216 may be hosted on the call server 207.

The recording agent 216 may determine whether to record a communication to or from either of the entities involved in the communication. For example, a law enforcement agency may indicate that communications to and from a certain VoIP entity are to be recorded. In response, the recording agent 216 may update a data structure to indicate that the communications to and from the VoIP entity are to be recorded. Thereafter, when the recording agent 216 is presented with a setup packet that involves the VoIP entity, the recording agent 216 may take actions, described in more detail below, to ensure that the communication to and from the VoIP entity is recorded.

In particular, to ensure that the communication to and from the VoIP entity is recorded, the recording agent 216 may remove or otherwise indicate that there are no direct paths between the two entities. In a Session Initiation Protocol (SIP), this may be performed by removing local candidates from a list of available candidates in Session Description Protocol (SDP) parameters sent by a VoIP entity seeking to establish a connection with another VoIP entity. This forces the two entities to use a Traversal Using Relay NAT (TURN) relay server to communicate with each other. In other IP-based packet communication protocols, this may involve setting or resetting a flag, adding, changing, or removing one or more data structures involved with the protocol, or making some other change to indicate that either direct paths are not available or are not to be used.

Sometimes herein, examples are given of using SIP, SDP, Session Traversal Utilities for NAT (STUN), and TURN. It is to be understood, however, that in other embodiments, the teachings herein may also be applied to communications protocols involved with other packet-based communication protocols used to transmit at least audio between two devices. Some exemplary other protocols include Media Gateway Control Protocol (MGCP), XAMPP, other audio transmission protocols, and the like. The audio transmission protocols mentioned above are not intended to be all-inclusive or exhaustive. Indeed, based on the teachings herein, those skilled in the art may recognize other audio transmission protocols to which aspects of the subject matter herein may be applied without departing from the spirit or scope of aspects of the subject matter herein. Furthermore, references mentioned herein to deleting or removing parameters in a SDP are to be interpreted in other embodiments to involve making additions, deletions, and/or changes as appropriate for other communication protocols to indicate that direct paths are not to be used.

The STUN/TURN protocols have been created to augment protocols such as SIP used in VoIP to allow a VoIP entity to operate across a NAT device such as the NAT device 214 and any NAT devices that connect entities in the enterprises 209-210 to the network 235. NAT devices may be placed at the edge of network segments for security and IP address management. An enterprise may deploy a NAT device, for example, to maintain address control and security. A NAT device allows connections that originate from within the enterprise and blocks connections that originate from outside the enterprise. VoIP protocols, however, are natively not compatible with these devices. The STUN/TURN protocols when combined with SIP and SDP provide a mechanism for NAT traversal. This is accomplished by adding candidate markers to the SDP used by SIP which can be used to determine if a NAT is in the proposed voice path and if so to terminate the call ends on a server on the far end of the NAT. If both call legs are on a local side of the NAT, VoIP entities may be directly connected together.

In SIP, exemplary SDP parameters for a request to establish a connection between two VoIP entities may include:

v=0
o=−0 0 IN IP4 192.168.0.2
s=session
c=IN IP4 192.168.0.2
b=CT:1000
t=0 0
m=audio 49170 RTP/AVP 97 110
a=rtcp:49170
a=candidate:123 1.0 UDP IP4 192.168.0.2 49170 xcyca87sbb

nmjs982lkm

a=candidate:124 0.8 UDP IP4 57.18.21.216 32999 692msld8po

creqpsm762

a=candidate:125 0.6 UDP IP4 12.1.2.6 4000 sdakjh980o

09sd2lk0fj

a=candidate:127 0.4 TLS IP4 12.1.2.7 41002 passive
a=ssrc-upper:0x6f12
a=ssrc-lower:0xaa9f
...
m=video 49170 RTP/AVP 34 31
a=rtcp:49170
a=candidate:123 1.0 UDP IP4 192.168.0.2 49170 xcyca87sbb

nmjs982lkm

a=candidate:124 0.8 UDP IP4 57.18.21.216 32999 692msld8po

creqpsm762

a=candidate:125 0.6 UDP IP4 12.1.2.6 4000 sdakjh980o

09sd2lk0fj

a=candidate:127 0.4 TLS IP4 12.1.2.7 41002 passive
a=ssrc-upper:0x6f12
a=ssrc-lower:0xaa9f

The lines bolded above may indicate local candidate communication points (e.g., protocols, IP addresses, port numbers, other IP information, and the like) that may be used to communicate with the initiating VoIP Entity.

If SIP invite messages are intercepted on their way to the call server or in the call server then the “a=candidate” lines referring to a direct peer to peer voice connection may be removed from the SDP parameters. As a result, the terminating call VoIP entity is not offered local paths and will not respond with them in the answer SDP. This forces the call through the NAT and into the public network where it can be transparently recorded.

For example, referring to the SDP example above, to cause the entities to communicate via a relay server, the bolded lines above may be deleted from the SDP parameters. These entries may be deleted via the recording agent 216 of the call server 207. The recording agent 216 comprises a component that is allowed to view and modify, if desired, the SDP parameters.

In one embodiment, the recording agent 216 may comprise a software module that logically and/or physically sits between the call server and the network 235. In this embodiment, the recording agent 216 may have access to each communication sent to and from the call server 207. The recording agent 216 may access a data structure, database, or the like to determine whether the communication is to or from an entity of interest. If the communication is not to or from an entity of interest, the recording agent 216 may pass the communication without changes to the call server 207. If the communication is of interest, the recording agent 216 may delete the parameters in the SDP that indicate a direct path to a VoIP entity. The recording agent 216 may then pass the SDP as changed to the call server 207.

In another embodiment, the recording agent 216 may comprise a component that is called by the call server when certain events occur. For example, the call server 207 may call the recording agent 216 when the call server 207 receives a request to establish a connection that involves a VoIP entity. In response, the recording agent 216 may determine whether any VoIP entity involved with the connection is of interest and, if so, modify the SDP to delete the parameters that indicate a direct path to the initiating entity.

As used herein, the term component is to be read to include all or a portion of a device, a collection of one or more software modules or portions thereof, some combination of one or more software modules or portions thereof and one or more devices or portions thereof, and the like.

After these lines are deleted, the VoIP entities and/or the call server 207 may execute one or more algorithms that determine an optimal communication path based on the remaining information included in the SDP parameters. Because the SDP parameters no longer include direct paths, the remaining parameters may dictate that all subsequent communication between the entities is to pass through the call gateway 212. In particular, using the remaining parameters, algorithms executed on the call server 207 and/or the VoIP entities may cause the VoIP entities to communicate via the call gateway 212.

The call gateway 212 may connect to the network 235 via a router 211. The router 211 may include the recording agent 218. The recording agent 218 may be configured to record and/or create a duplicate stream for communications that pass through the call gateway 212. This recording and/or duplicate stream may then be passed to a law enforcement agency via the intercept requestor 208.

In some embodiments, it may be possible to have recording agent on one or more devices (e.g., routers, switches, NATs, edge devices, and the like) of an enterprise. This recording agent may periodically check with or otherwise be informed by an intercept requestor as to VoIP entities for which recording is to be performed. The recording agent(s) 217 of the enterprise 209 illustrates this possibility.

Although the environment described above includes various numbers of the entities and related infrastructure, it will be recognized that more, fewer, or a different combination of these entities and others may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

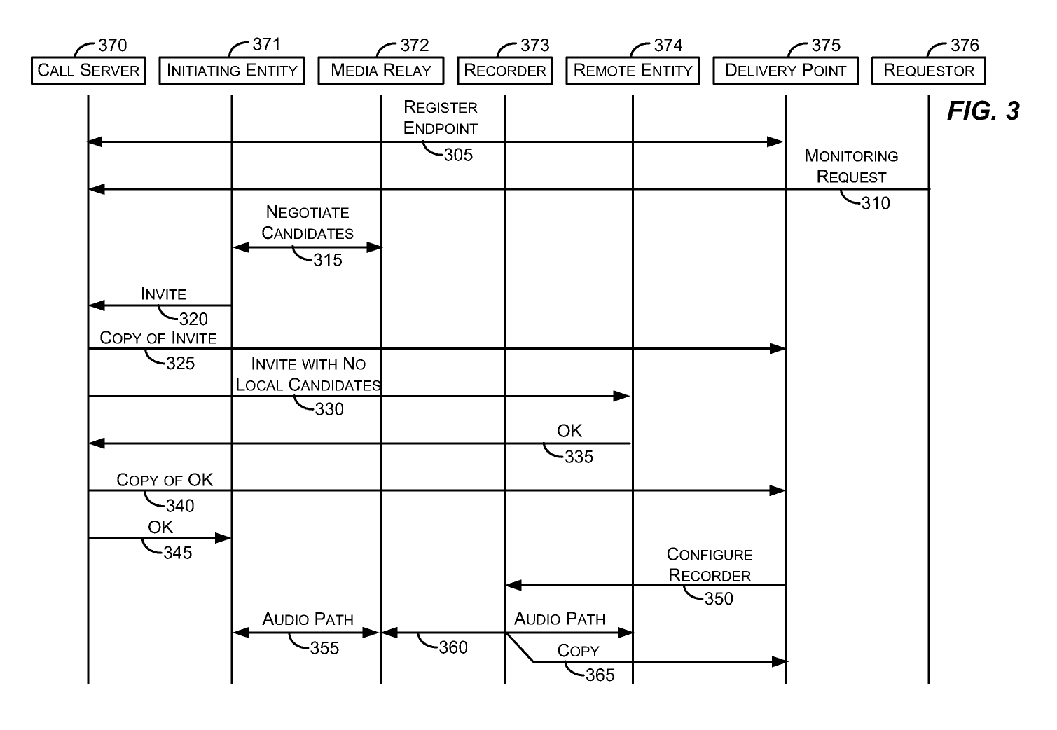

FIG. 3 is an exemplary timing diagram that illustrates a sequence of events that may occur in accordance with aspects of the subject matter described herein. The timing diagram illustrates interactions between various entities including a call server 370, an initiating entity 371, a media relay 372, a recorder 373, a remote entity 374, a delivery point 375, and a requestor 376. The call server 370 corresponds to the call server 207 of FIG. 2.

The initiating entity 371 corresponds to a VoIP entity that seeks to establish a connection with another VoIP entity. The initiating entity may correspond to any of the VoIP entities 205-206 or a VoIP entity of the enterprises 209-210 of FIG. 2.

The media relay 327 corresponds to the call gateway 212 of FIG. 2. The recorder 373 may correspond to any of the recording agents 216-218 of FIG. 2.

The remote entity 374 corresponds to a VoIP entity with which the initiating entity 371 seeks to establish a connection. In other words, the remote entity is the entity the initiating entity is trying to call. Referring to FIG. 2, the remote entity 374 may correspond to any of the VoIP entities 205-206 or a VoIP entity of the enterprises 209-210.

The requestor 376 is a device by which a law enforcement agency may make a request to monitor and record communications to and from a designated VoIP entity. In making a request, the requestor 376 may designate the delivery point 375 for the recorded communications. Referring to FIG. 2, the requestor 376 may correspond to the intercept requestor 208.

The delivery point 375 may comprise a device to which copies of packets are sent. For example, referring to FIG. 2, the delivery point 375 may comprise an IP address/port of the intercept requestor 208.

At 305, a delivery endpoint is registered with a call server. For example, referring to FIG. 2 the intercept requestor 208 may register an IP address/port for delivery of copies of recorded communications associated with a designated VoIP entity.

At 310, a request to monitor a selected VoIP entity is sent by the requestor to the call server. For example, referring to FIG. 2, the intercept requestor 208 may request that the call server 207 record communications for the VoIP entity 206.

At 315, an initiating entity negotiates candidate network paths with a media relay. For example, referring to FIG. 2, the VoIP entity 206 may talk to a STUN, TURN, and/or other servers to determine what IP address/port of the VoIP entity 206 is visible from the network 235. For example, if the VoIP entity 206 is connected to a NAT, the NAT may translate IP addresses and port numbers. In STUN/TURN environments, the call gateway 212 may act as a STUN and/or TURN server. The SDP parameters indicated previously are an example of what may result as the entity negotiates candidate communication points with a media relay.

At 320, the initiating entity sends an invite to the call server. The invite includes data regarding establishing a communication session between at least two entities via a switched packet network for a communication that includes audio. For example, referring to FIG. 2, the VoIP entity 206 sends an invite (such as the SDP parameters mentioned previously) to the call server 207 to communicate with a VoIP entity in the enterprise 209.

At 325, a copy of the invite is sent to the delivery point. For example, referring to FIG. 2, the call server 207 may send a copy of the invite to the intercept requestor 208 or another endpoint designated by the intercept requestor 208.

At 330, an invite with no local candidates is sent to the remote entity. For example, referring to FIG. 2, the call server 207 sends an SDP with the local candidates deleted to the remote entity of the enterprise 209. Having no local candidates is synonymous with having “no direct paths.” In STUN/TURN terminology, this means that the VoIP entity needs to employ a TURN server to communicate with the remote entity.

At 335, the remote entity responds to the invite by sending “OK.” For example, referring to FIG. 2, the remote entity in the enterprise 209 responds to the invite by sending an OK to the call server 207.

At 340, a copy of the OK is sent to the delivery point. For example, referring to FIG. 2, the call server sends a copy of the OK to the intercept requestor 208 or another endpoint designated by the intercept requestor 208.

At 345, the OK is sent to the initiating entity. For example, referring to FIG. 2, the call server sends the OK to the VoIP entity 206.

At 350 the agent that will be recording the subsequent communication between the entities is configured so that it will create a copy of the communication. For example, referring to FIG. 2, the call server 207, the call gateway 212, or some other server may configure the router 211 to create a copy of the communication to and from the VoIP entity 206. Note, that the recorded may be configured to record a communication for an entity any time after a monitoring request for the entity is received.

At 355, the VoIP entity sends a packet to the media relay. For example, referring to FIG. 2, the VoIP entity 206 may send a packet to the call gateway 212.

At 360, the packet passes to the recorder. For example, referring to FIG. 2, the packet may pass to the router 211.

At 365, the packet is sent to the remote entity. In addition, a copy of the packet is sent to the delivery point and/or stored for later sending to the delivery point or retrieval by a law enforcement agent. For example, referring to FIG. 2, the router 211 sends the packet to the VoIP entity in the enterprise 209 and sends a copy of the packet to the intercept requestor 208 or another endpoint designated by the intercept requestor 208. This continues until the communication is terminated.

Upon termination, the delivery endpoint may be informed that the communication has terminated.

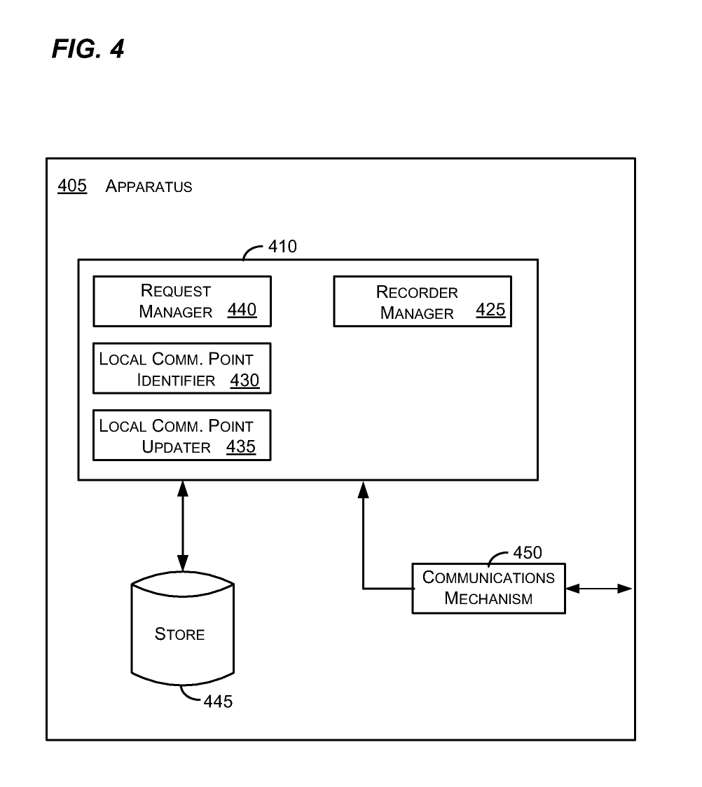

FIG. 4 is a block diagram that represents an apparatus configured in accordance with aspects of the subject matter described herein. The components illustrated in FIG. 4 are exemplary and are not meant to be all-inclusive of components that may be needed or included. In other embodiments, the components and/or functions described in conjunction with FIG. 4 may be included in other components (shown or not shown) or placed in subcomponents without departing from the spirit or scope of aspects of the subject matter described herein. In some embodiments, the components and/or functions described in conjunction with FIG. 4 may be distributed across multiple devices.

Turning to FIG. 4, the apparatus 405 may include recording agents 410, a store 445, a communications mechanism 450, and other components (not shown). The apparatus 405 corresponds to any entity of FIG. 2 that may host recording agents including the call server 207, a device of the enterprise 209, the router 211, or another entity and may be implemented on or as the same or similar device(s) upon which one of those entities may be implemented. For example, the apparatus 405 may be implemented on or as a computer (e.g., as the computer 110 of FIG. 1).

The recording agents 410 correspond to the recording agents that may be found on entities of FIG. 2. The recording agents 410 may include a request manager 440, a local communication point identifier 430, a local communication point updater 435, a recorder manager 425, and other components (not shown).

The communications mechanism 450 allows the apparatus 405 to communicate with other entities. For example, the communications mechanism 450 allows the apparatus to communicate with other entities reachable via the network 235 of FIG. 2. The communications mechanism 450 may be a network interface or adapter 170, modem 172, or any other mechanism for establishing communications as described in conjunction with FIG. 1.

The store 445 is any storage media capable of providing access to data used or generated by the recording agents 410. The store 445 may comprise a file system, database, volatile memory such as RAM, other storage, some combination of the above, and the like and may be distributed across multiple devices. The store 445 may be external, internal, or include components that are both internal and external to the apparatus 405.

The request manager 440 may be operable to receive a request to establish a communication session between entities that are capable of communicating audio data via a sequence of network packets. For example, referring to FIG. 2, a request manager hosted on the call server may receive a request to establish a communication session from an entity of the enterprise 210.

The request manager 440 may be further operable to receive data usable to establish one or more network paths between the entities. This data may include one or more local candidate communication points of at least one of the entities.

The local communication point identifier 430 may be operable to locate parameters in the data that indicate local candidate communication points of the entities for which a communication session is desired.

The local communication point updater 435 may be operable to modify the data to indicate that the one or more local candidate communications points are not to be used when establishing the communication session between the entities. Modifying the data may include removing parameters, changing parameters, and/or adding additional parameters as indicated previously.

The recording manager 425 may be operable to configure a recording agent (e.g., a router or other agent) to silently copy communication transmitted via the communication session. The terms “silently copy” and “silently record” each indicates that the agent produces a copy of the communication without informing either communicating entity that a copy is being made.

In one embodiment, when a communication is silently copied or recorded, this refers to copying packets of the communication and forwarding these packets as they occur to a delivery point. In this embodiment, the recording agent does not need to store a copy of the entire communication and may not store any copy of packets at all beyond the time it takes to forward the packets. Instead, the recording agent may copy and forward packets of the communication as they are received by the recording agent and discard the packets after they are forwarded.

In another embodiment, when a recording agent silently records or copies a communication, the recording agent may create a recording that includes one or more of the packets of the communication or even the entire communication and may wait to provide these one or more packets or the entire communication until a later time such as periodically or after the communication terminates.

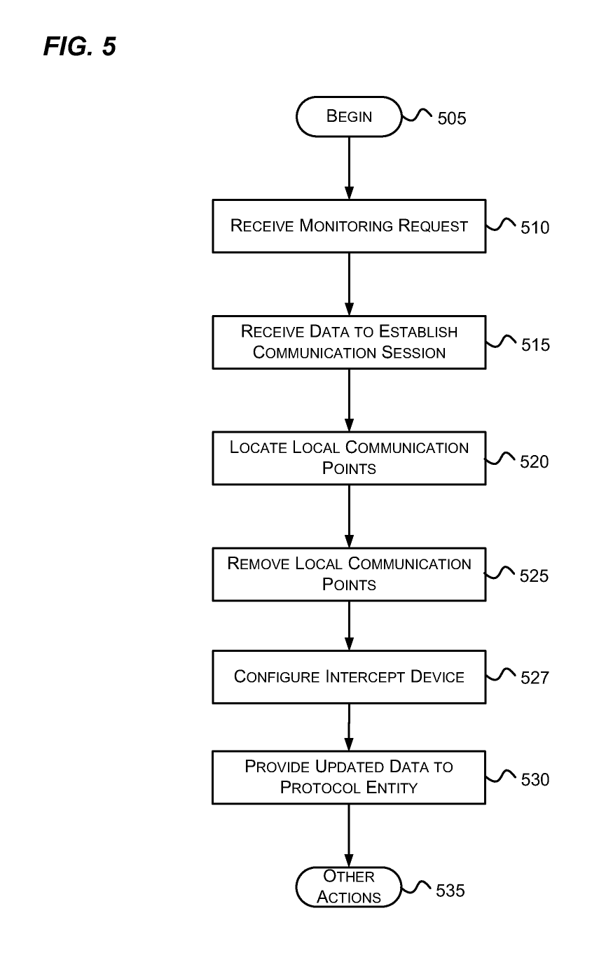

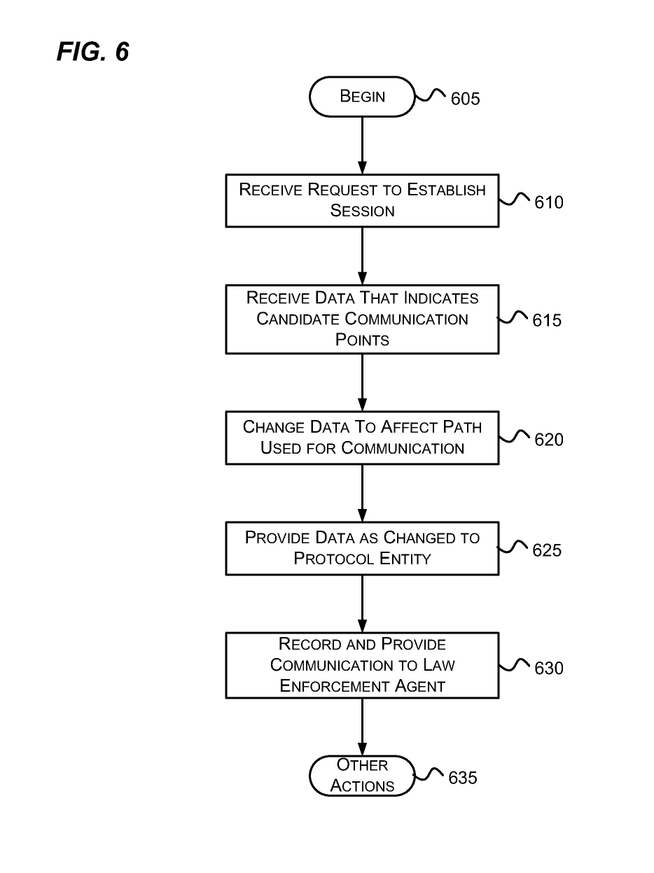

FIGS. 5-6 are flow diagrams that generally represent actions that may occur in accordance with aspects of the subject matter described herein. For simplicity of explanation, the methodology described in conjunction with FIGS. 5-6 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a

Turning to FIG. 5, at block 505, the actions begin. For example, referring to FIG. 2, a law enforcement agent may seek to obtain recording of communication to and from the VoIP entity 206.

At block 510, a request to monitor communications to and from a VoIP entity is received. For example, referring to FIG. 2, the call server 207 may receive a request to monitor communications to and from the VoIP entity 206. The request to monitor communications may include a request to monitor packets to and from the VoIP entity 206. In response to receiving the request, a database may be updated with an identifier of the VoIP entity 206.

At block 515, data regarding establishing a communication session is received. For example, referring to FIG. 2, the call server 207 may receive a request from the VoIP entity 206 to establish a communication session with a VoIP entity of the enterprise 209. The communication session may be used to transmit a communication between the entities via a switched packet network. The communication may include audio as well as other data. In conjunction with receiving the request, data may be transmitted that indicates on or more local candidate communication points of at least one of the entities.

In another example, the data regarding establishing a communication session may be received by a recording agent that is logically disposed between an entity that is requesting the establishment of the communication session (sometimes referred to as the “requesting entity”) and a call server that is involved in establishing the communication session. For example, referring to FIG. 2, the data may be received by an entity (not shown) that sits between the call server 207 and the network 235.

At block 520, parameters that indicate the local communication points are located within the data. For example, referring to FIG. 4, the local communication point identifier 430 may locate parameters that include the local communication points within the data. For example, the bolded lines of the exemplary SDP previously described may be located.

At block 525, the local communication points may be removed. Removing the local communication points may include removing the parameters previously located. Because the parameters are removed, this causes the communication session to be established over a public path (e.g., that includes a TURN or other server). The public path may include a component that includes a recording agent that is capable of silently copying the communication between the two entities. As mentioned previously, in embodiments for other audio transmission protocols, instead of removing the local communication points, additions, deletions, and/or other changes may be made as appropriate for the other communication protocols to indicate that direct paths are not to be used.

At block 527, a network device is configured to intercept and copy communication that occurs via the communication session. The network device is logically disposed within a path over which the communication session is to take place. For example, referring to FIG. 2, the router 211 may be configured to copy the communication. This network device may create one or more additional streams when forwarding a stream associated with the communication. These one or more additional streams may be forwarded to an entity identified previously (e.g., an entity identified by the intercept requestor 208 in conjunction with providing the monitor request).

At block 530, the updated data with the parameters removed is provided to a protocol entity that uses the data to follow a communication protocol to establish the communication session via the path. The protocol entity may potentially include one or more of the entities that are to communicate using the communication session and/or any entity (e.g., router, server, switch, other network device, and the like) that interacts with one or more of the entities.

After receiving the updated data, the entities may determine the communication path using the updated data. Because of the updated data, this communication path passes includes a device that may silently record the communication.

At block 535, other actions, if any, may be performed.

Turning to FIG. 6, at block 605, the actions begin. For example, referring to FIG. 2, a law enforcement agent may seek to obtain recording of communication to and from the VoIP entity 206.

At block 610, a request to establish a communication session between entities is received. The entities are capable of communicating at least audio data via a sequence of network packets. For example, referring to FIG. 2, the call server 207 may receive a request to establish a communication with the VoIP entity 206. The call server 207 resides (e.g., is located) in a call establishment communication path of at least one of the entities. This communication path transports attempts to establish communication sessions.

The call server 207 may be responsible for providing an invite that includes the data as changed to a receiving entity of the communication session. The receiving entity comprising an entity that did not send the request to the call server. For example, if the VoIP entity 206 did not request the establishment of the communication session, the call server 207 may provide a changed invite to the VoIP entity 206 as part of establishing the communication session.

At block 615, in conjunction with receiving the request, data may be received that indicates one or more candidate communication points of at least one of the entities. This data may be formatted according to a communication protocol (e.g., such as SDP or another communication protocol). For example, referring to FIG. 2, the call server 207 may receive an SDP invite packet in conjunction with receiving the request.

At block 620, the data is changed to cause a protocol entity that uses the data while following the communication protocol to establish the connection via a path that includes a recording agent that is capable of silently copying the communication between the entities. The protocol entity as used here potentially includes one or more of the communicating entities and/or any entity that interacts with one or more of the communicating entities. For example, referring to FIG. 4, the local communication point updater 435 may modify the SDP invite packet to remove local communication points.

As mentioned previously, changing the data may involve changing a flag or other data within the data, adding additional data to the data, and/or deleting parameters from the data. In each case, changing the data indicates that the communication session is to use a path that includes a recording agent.

At block 625, the data as changed is provided to a protocol entity. For example, referring to FIG. 2, the call server 207 may provide a modified invite to the VoIP entity 206. After receiving the updated data, the VoIP entities may determine the communication path using the updated data. Because of the updated data, this communication path includes a device that may silently record the communication.

At block 630, the communication is silently recorded and provided to an entity designated by a law enforcement agent. For example, referring to FIG. 2, the router 211 may record the communication to and from the VoIP entity 206 and provide a copy of the communication to an entity indicated by the intercept requestor 208. Prior to the recordation, the recording agent may be configured to create a copy of data transmitted in the communication session and to send the copy to an entity associated with a law enforcement agent. To silently record the communication and provide a copy to the entity indicated by the intercept requestor 208, in one embodiment, the router 211 may send a copy of each packet it receives of the communication as soon as the router 211 receives each packet. In this embodiment, the entity indicated by the intercept requestor 208 may receive the packets in real time.

In another embodiment, the router 211 may store copies of one or more packets or even a complete communication before sending the packets or complete communication to the entity.

At block 635, other actions, if any, may be performed.

As can be seen from the foregoing detailed description, aspects have been described related to silently recording communications. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving data regarding establishing a communication session between at least two entities via a switched packet network for a communication that includes audio;
locating one or more parameters in the data that indicate one or more local candidate communication points of at least one of the at least two entities;
removing the one or more parameters from the data to cause the communication session to be established over a path that includes a recording agent that is capable of silently copying the communication between the at least two entities; and
providing the data with the parameters removed to a protocol entity that uses the data to follow a communication protocol to establish the communication session via the path, the protocol entity potentially including one or more of the at least two entities and/or any entity that interacts with one or more of the at least two entities.

2. The method of claim 1, wherein receiving data regarding establishing a communication session between at least two entities comprises receiving the data from a call server that is involved in establishing the communication session, the call server responsible at least for relaying invite requests from a requesting one of the entities to a receiving one of the entities, the call server configurable to provide the data to a recording agent before establishing the communication session.

3. The method of claim 1, wherein receiving data regarding establishing a communication session between two entities comprises receiving the data at a recording agent logically disposed between a requesting entity of the at least two entities and a call server that is involved in establishing the communication session.

4. The method of claim 1, wherein removing the one or more parameters from the data comprises deleting the one or more parameters from session description protocol data that includes the data.

5. The method of claim 1, further comprising receiving a request to monitor packets to and from at least one of the at least two entities and updating a database with an identifier of the at least one of the at least two entities in response to the request.

6. The method of claim 5, further comprising configuring a network device to create a copy of the communication in response to receiving the request, the network device logically disposed within the path.

7. The method of claim 1, further comprising creating a copy of the communication by creating at least one additional stream in conjunction with creating a stream associated with the communication.

8. The method of claim 7, further comprising forwarding the at least one additional stream to an entity identified prior to receiving the data.

9. The method of claim 1, further comprising storing data corresponding to the communication to a storage medium for later retrieval by a law enforcement agent.

10. The method of claim 1, wherein receiving data regarding establishing a communication session comprises receiving session description protocol parameters according to a session initiation protocol of a voice over Internet protocol.

11. A computer storage medium having computer-executable instructions, which when executed perform actions, comprising:
receiving a request to establish a communication session between at least two entities that are capable of communicating at least audio data via a sequence of network packets;
in conjunction with receiving the request, receiving data that indicates one or more candidate communication points of at least one of the at least two entities, the data formatted according to a communication protocol; and
changing the data to cause a protocol entity that uses the data while following the communication protocol to establish the connection via a path that includes a recording agent that is capable of silently copying the communication between the at least two entities, the protocol entity potentially including one or more of the at least two entities and/or any entity that interacts with one or more of the at least two entities; and
providing the data as changed to the protocol entity.

12. The computer storage medium of claim 11, wherein receiving a request to establish a communication session comprises receiving the request at a component that resides in a communication path of at least one of the at least two entities, the communication path transporting attempts to establish communication sessions that include audio.

13. The computer storage medium of claim 11, wherein receiving a request to establish a communication session comprises receiving the request at a call server that is responsible for providing an invite indicating the data as changed to a receiving entity of the at least two entities, the receiving entity comprising an entity that did not send the request to the call server.

14. The computer storage medium of claim 11, wherein changing the data comprises changing a flag, the flag indicating that the path that includes the recording agent be used for the communication session.

15. The computer storage medium of claim 11, wherein changing the data comprises adding additional data to the data, the additional data indicating that the path that includes the recording agent is to be used for the communication session.

16. The computer storage medium of claim 11, wherein changing the data comprises deleting parameters from the data leaving remaining parameters in the data, the remaining parameters indicating that the path that includes the recording agent is to be used for the communication session.

17. The computer storage medium of claim 11, wherein receiving data that indicates one or more candidate communication points of at least one of the at least two entities comprises receiving Internet protocol data that identifies ports and Internet protocol addresses of network address translation devices associated with the at least two entities.

18. The computer storage medium of claim 11, further comprising configuring the recording agent to create a copy of data transmitted in the communication session and to send the copy to an entity associated with a law enforcement agent.

19. In a computing environment, an apparatus, comprising:
a request manager operable to receive a request to establish a communication session between at least two entities that are capable of communicating at least audio data via a sequence of network packets, the request manager further operable to receive data usable to establish one or more network paths between the at least two entities;
a local communication point identifier operable to locate one or more parameters in the data that indicate one or more local candidate communication points of at least one of the at least two entities; and
a local communication point updater operable to modify the data to indicate that the one or more local candidate communications points are not to be used when establishing the communication session between the at least two entities.

20. The apparatus of claim 19, further comprising a recorder manager operable to configure a recording agent to silently copy communication transmitted via the communication session.
